(19) United States
(12) Patent Application Publication
(10) Pub. No.: US 2026/0218837 A1
(43) Pub. Date: Jul. 30, 2026

(54) METHOD AND APPARATUS FOR CORROSION MITIGATION IN WET PIPES

(71) Applicant: GENERAL AIR PRODUCTS, INC., Exton, PA (US)

(72) Inventors: Mark A. LASKARIS, Collegeville, PA (US); Ron E. MCCLELLAN, Gilbertsville, PA (US); Richard A. WEST, Montgomery, TX (US)

(73) Assignee: GENERAL AIR PRODUCTS, INC., Exton, PA (US)

(21) Appl. No.: 19/039,840

(22) Filed: Jan. 29, 2025

(51) Int. Cl. F16L 58/00; G05D 11/13; G08B 21/18

(52) U.S. Cl. CPC F16L 58/00; G05D 11/138; G08B 21/182

(57) ABSTRACT

A system for injecting corrosion inhibitor into a liquid piping system includes a flow rate sensor configured to determine a flow rate of liquid entering the liquid piping system, an injector configured to inject corrosion inhibitor into the liquid piping system an injection point in an amount which varies based on the flow rate determined by the flow rate sensor, the injector being disposed in a fluid passage which is connected at a first end to a vessel containing corrosion inhibitor and at a second end to the injection point, a concentration sensor configured to determine a concentration of corrosion inhibitor in the liquid in the liquid piping system, and an alarm which generates an alarm signal if the concentration determined by the concentration sensor is outside a predetermined range.

### TECHNICAL FIELD

The present disclosure relates to a system and method for injecting corrosion inhibitor into a liquid piping system.

### BACKGROUND

Corrosion can lead to significant problems in liquid piping systems, such as fire sprinkler piping systems, cooling tower systems, boiler systems, wastewater systems, and various systems having agricultural applications. For example, water having a high mineral content can cause scaling as the various dissolved minerals, such as calcium and zinc, react with the water and the pipes to form mineral deposits on the inside walls. Such mineral deposits can inhibit flow or break free and clog sprinkler heads, potentially preventing proper discharge in the event of a fire. Furthermore, various water borne microbiological entities, such as iron oxidizing bacteria and sulfate reducing bacteria, are also known to cause corrosion in metal pipes.

Attempts have been made to address such issues with water treatment systems that use corrosion inhibitors. However, a need remains for efficient, accurate, repeatable corrosion inhibitor injection systems for water-based piping systems, for example fire sprinkler systems.

### SUMMARY

A system for injecting corrosion inhibitor into a liquid piping system includes a flow rate sensor configured to determine a flow rate of liquid entering the liquid piping system, and an injector configured to inject corrosion inhibitor into the liquid piping system at an injection point in an amount which varies based on the flow rate determined by the flow rate sensor, the injector being disposed in a fluid passage which is connected at a first end to a vessel containing corrosion inhibitor and at a second end to the injection point.

A method for injecting corrosion inhibitor into a liquid piping system includes determining, by a flow rate sensor, a flow rate of liquid entering the liquid piping system, and injecting, by an injector, corrosion inhibitor into the liquid piping system at an injection point in an amount which varies based on the flow rate determined by the flow rate sensor, the injector being disposed in a fluid passage which is connected at a first end to a vessel containing corrosion inhibitor and at a second end to the injection point.

### BRIEF DESCRIPTION OF THE DRAWINGS

Other features and advantages disclosed herein will become more apparent from the following detailed description of illustrative embodiments when read in conjunction with the attached drawings.

FIG. 1 is a schematic representation of a cross-sectional view of an illustrative embodiment of a corrosion risk reduction module.

FIG. 1A is a schematic representation of a cross-sectional view of an illustrative embodiment of a corrosion risk reduction module.

FIG. 1B is a schematic representation of a cross-sectional view of an illustrative embodiment of a corrosion risk reduction module.

FIG. 1C is a schematic representation of a cross-sectional view of an illustrative embodiment of a corrosion risk reduction module.

FIG. 2 is a schematic representation of a side view of an illustrative embodiment of a corrosion risk reduction module.

FIG. 3 is a schematic representation of a side view of an illustrative embodiment of a corrosion risk reduction module.

FIG. 4 is a block diagram illustrating a high-level system architecture of the systems of FIGS. 2-4 for injecting corrosion inhibitor into a liquid piping system in accordance with exemplary embodiments.

FIG. 5 is a block diagram illustrating the controller in the system of FIGS. 2-4 for injecting corrosion inhibitor into a liquid piping system in accordance with exemplary embodiments.

FIG. 6 is a flow chart illustrating an exemplary method for injecting corrosion inhibitor into a liquid piping system in accordance with exemplary embodiments.

FIG. 7 is a block diagram illustrating a computer system architecture in accordance with exemplary embodiments.

### DETAILED DESCRIPTION

### Manual System for Injecting Corrosion Inhibitor

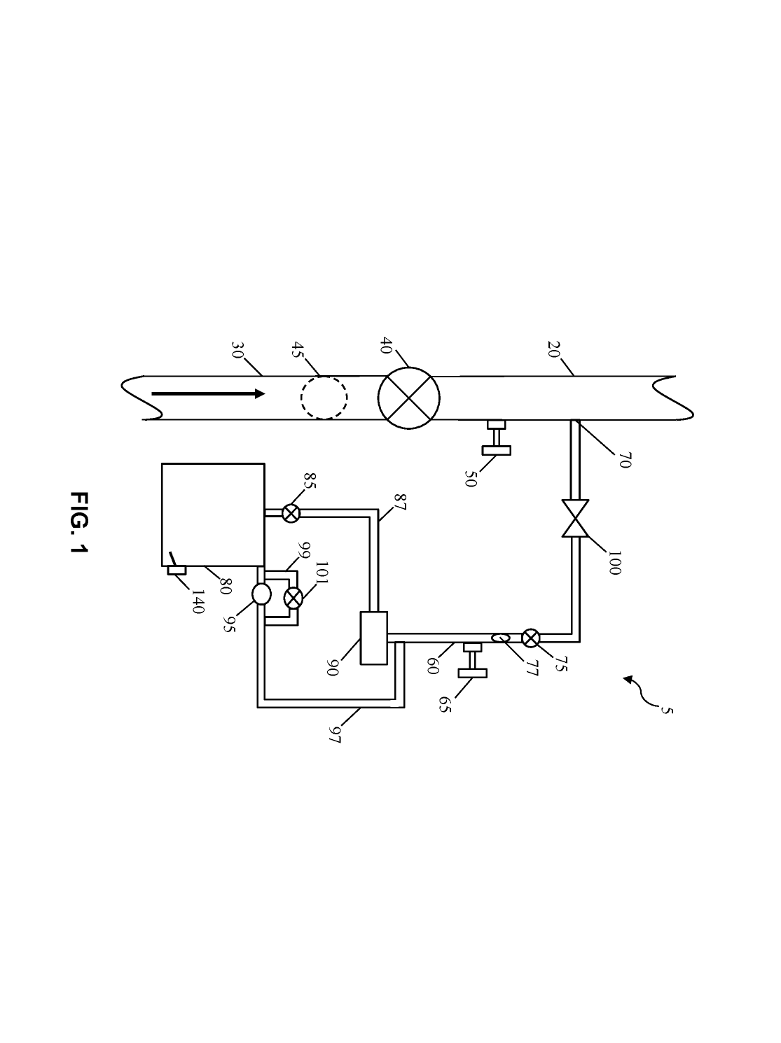

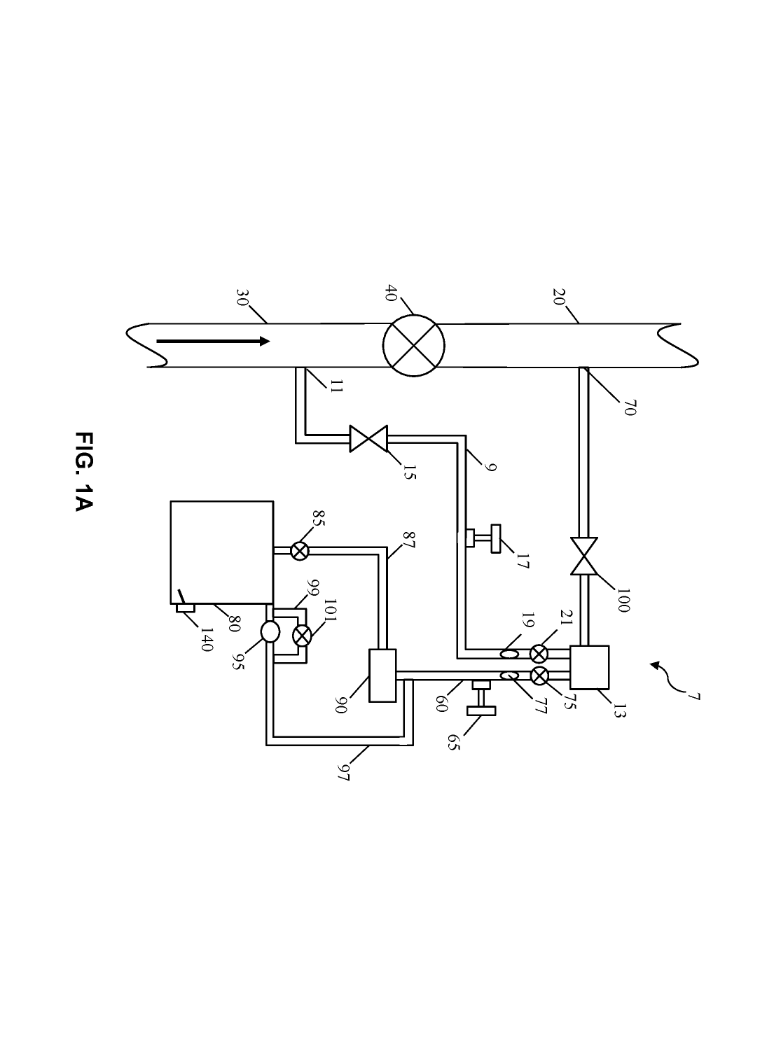

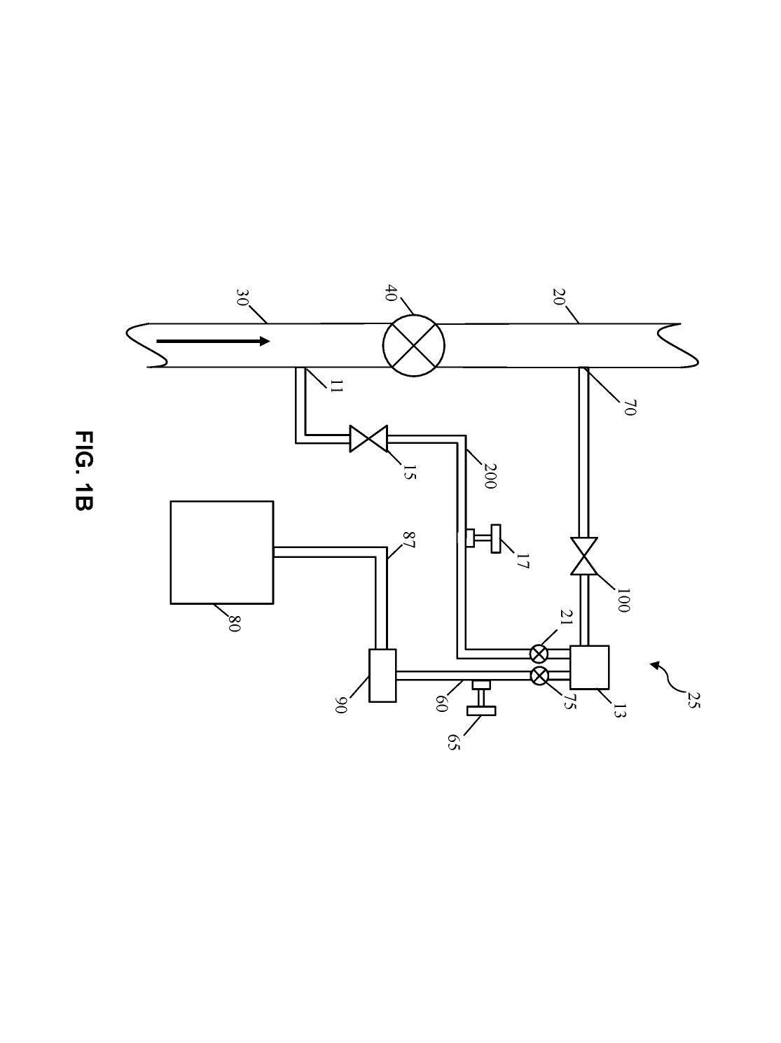

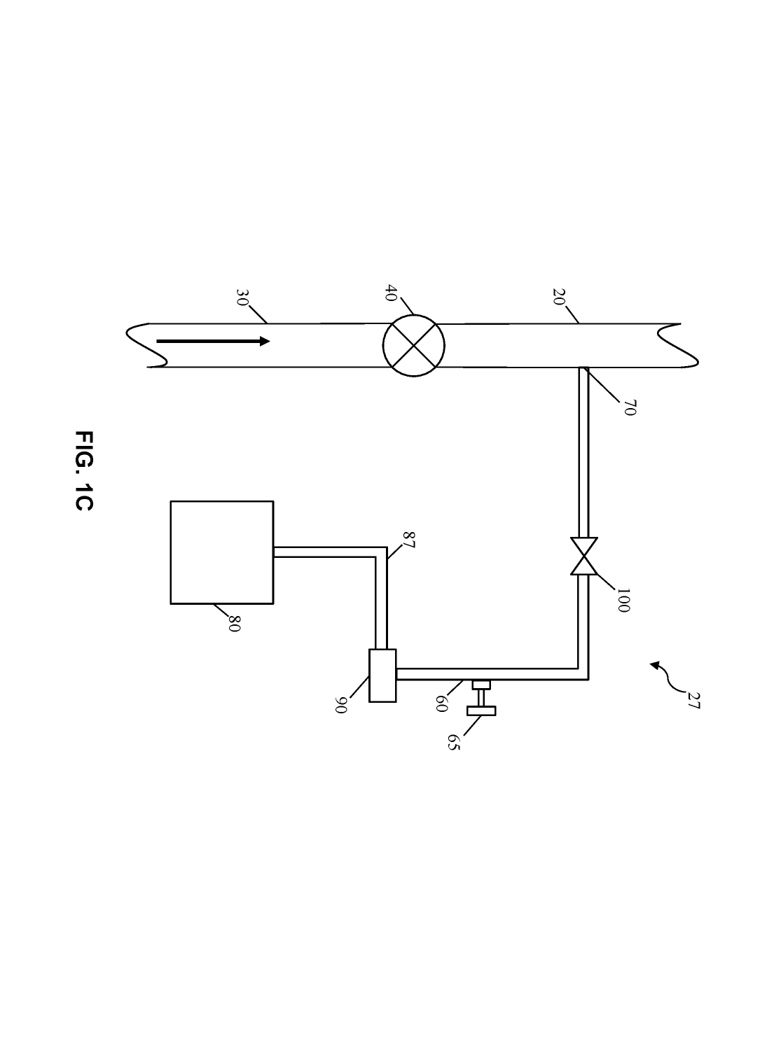

FIG. 1 illustrates a system 5 for injecting corrosion inhibitor into a liquid piping system. Specifically, the system 5 is a manually operated corrosion inhibitor injection system in which a user manually operates adjustment valves for both a system input liquid (e.g., water, steam, antifreeze, industrial chemicals, or any liquid that might permit corrosion in a liquid piping system) and system corrosion inhibitor input. The system 5 includes at least one liquid pipe 20 which can be, for example, a part of a main for a wet fire sprinkler system, cooling tower systems, boiler systems and other liquid based heating systems, wastewater systems, various systems having agricultural applications, and any system that might exhibit similar corrosion concerns. The liquid pipe 20 is connected to a liquid source 30 by a normally open flow valve 40. Valve 40 may be closed during the corrosion inhibiting mixture fill process, or other service, such as described below. The liquid source 30 can be, for example, piping connected to a commercial water supply, a water tower, a water well system, boiler, or any other suitable liquid supply. The flow valve 40 can be, for example, an outside screw and yoke gate valve or a control valve and is configured to be opened manually when the liquid piping system needs to be refilled with liquid. Once the flow valve 40 is opened, liquid from the liquid source 30 flows initially through the liquid pipe 20 and then through the remainder of the liquid piping system until the liquid piping system has been re-filled, and then the flow valve 40 is closed or remains open in the case of a fire sprinkler system. The system 5 includes an optional first check valve 45 disposed in or as part of the liquid pipe 20 to prevent a backflow of the liquid within the liquid pipe 20. The first check valve 45 can be any suitable type of check valve capable of preventing the backflow of a liquid through a pipe such as, but not limited to, a lift check valve, a piston check valve, a ball check valve, a swing check valve, a butterfly check valve, a stop check valve, a spring-loaded check valve, and/or a wafer check valve etc. as required for the specific application.

The system 5 includes a flow rate sensor 50 which is disposed in, on, or near the liquid pipe 20 and configured to determine a flow rate of liquid entering the liquid pipe 20. The flow rate sensor 50 can be, for example, but not limited to, an ultrasonic flow meter, an electromagnetic flow meter, a mechanical liquid flow meter, or a vortex volumetric flow meter, etc. Further, the flow rate sensor 50 can be, for example, but not limited to, a clamp-on flow meter that is attached to or positioned externally to the liquid pipe 20 or a flow meter that is partially or fully disposed in the liquid pipe 20. The flow rate sensor 50, while illustrated as being located downstream of the valve 40 and the check valve 45, may be located upstream of valve 40 and/or check valve 45 as long as the flow rate sensor can measure the water flow input into the system 5 in its entirety. In embodiments, the flow rate sensor 50 can include a digital display that displays the detected flow rate of the liquid entering the liquid pipe 20. The system 5 also includes a fluid passage 60 which is connected at one end to an injector pump 90 (e.g., centrifugal pump or any other type of pump that can fulfill the objects of this invention), and at another end to the liquid pipe 20 at an injection point 70 which is downstream of the flow rate sensor 50. The injection point 70, while illustrated as being located downstream of the flow rate sensor 50, can be located upstream of the flow rate sensor 50. In such embodiments where the injection point 70 is upstream of the flow rate sensor 50, the calculation of corrosion inhibitor to be injected into the system 5 would be different than if the injection point 70 was located downstream of the flow rate sensor 50 because the flow rate sensor 50 would be measuring the sum total of the untreated liquid and the corrosion inhibitor. The system 5 includes a second check valve 77 disposed in or as part of the fluid passage 60 to prevent a backflow of the corrosion inhibitor or system liquid from the liquid pipe 20 within the fluid passage 60. The second check valve 77 can be any suitable type of check valve capable of preventing the backflow of a liquid through a pipe such as, but not limited to, a lift check valve, a piston check valve, a ball check valve, a swing check valve, a butterfly check valve, a stop check valve, a spring-loaded check valve, and/or a wafer check valve, etc. Further, the system 5 includes an intake line 87 which is connected at one end to a vessel 80 containing a corrosion inhibitor, and at another end to the injector pump 90. The vessel 80 can be a plastic tank or any other suitable container capable of holding a sufficient amount of the corrosion inhibitor for the system 5. The corrosion inhibitor can be any liquid corrosion inhibitor for reducing the corrosion of the pipes in the liquid piping system (e.g., the system 5). In embodiments, the corrosion inhibitor is a vapor-phase corrosion inhibitor (VCI) capable of providing direct liquid-contact corrosion prevention and vapor-phase inhibition for the liquid piping system (e.g., the system 5). Vapor Phase Corrosion Inhibitors (VCI) come in a broad range of materials including liquids, powders or embedded in packaging that protect metal surfaces from corrosion by being attracted to a metal first, even under water; and then from the water, over time it will vaporize into any air pockets, protecting at the water line and above. The VCI particles travel through the air as a vapor and form a protective layer on the surface of metals which prevents oxygen, moisture and other corrosive elements from making contact with the metal surfaces. They work best in closed spaces where the particles are able to build up, such as piping systems. In a wet piping system, the VCI remains in the liquid until an air pocket, or the like where corrosion might occur, forms and the VCI becomes a vapor from the liquid. The injector pump 90 is configured to pump corrosion inhibitor from the vessel 80 through the fluid passage 60 to the injection point 70, where it is injected into the liquid pipe 20 and mixed with the liquid flowing therethrough, and its control of which is discussed in detail below. An isolation valve 100 in the fluid passage 60 downstream of the injector pump 90 is configured to open and close the fluid passage 60, and its control is also discussed in detail below. The injector pump 90 can be, for example, but not limited to, a diaphragm-type constant injection pump, a variable speed diaphragm-type pulse injector, a high-pressure piston dosing pump, or any suitable constant speed injector pump, or any suitable variable speed injector pump, etc. A diaphragm-type constant injection pump that includes a diaphragm, an inlet valve, an outlet valve, and a pump chamber that is filled and emptied by a piston. When the pump chamber of a diaphragm-type constant injection pump is full, the dosed volume of liquid is injected, e.g., into the fluid passage 60, at a constant flow rate, e.g., 6-250 liter/hour. A variable speed diaphragm-type pulse injector employs a diaphragm mechanism, which is controlled by a solenoid coil that sucks in and injects the corrosion inhibitor into the liquid pipe 20 in pulses. The time-gap between the pulses in a variable speed diaphragm-type pulse injector provides the control of the flow rate of liquid in the fluid passage 60. A high-pressure dosing pump is a mechanical piston pump that can be used as the injector pump 90 in systems requiring high-pressure applications. The high-pressure dosing pump can also be a constant speed injector pump. Furthermore, a second flow rate sensor 65 is provided in the fluid passage 60 to detect a flow rate of corrosion inhibitor in the fluid passage 60 and send a signal indicative of the flow rate. In the system 5, during injection of the corrosion inhibitor, a user operates a second flow valve 75. The second flow valve 75 can be, for example, an outside screw and yoke gate valve or a control valve (e.g., a gate, globe, ball, butterfly, plug, needle or nearly any other type of valve) and is configured to be opened manually or automatically when corrosion inhibitor is being injected into the fluid passage 60. Once the second flow valve 75 is opened, corrosion inhibitor from the vessel 80 through the fluid passage 60 to the injection point 70 where the corrosion inhibitor mixes with the liquid flowing through the liquid pipe 20 and then through the reminder of the liquid piping system.

The system 5 further includes a quantity sensor 140 (e.g., a level sensor) disposed in the vessel 80 and configured to display the amount of corrosion inhibitor that is remaining in the vessel 80. In embodiments, the vessel 80 may be partially or entirely transparent such that a user can visualize the amount of corrosion inhibitor remaining in the vessel 80. In such embodiments, the vessel 80 can include graduation marks on one or more walls of the vessel 80 to aid in determining the amount of corrosion inhibitor remaining in the vessel 80. In embodiments, the system 5 can include a third flow valve 85 attached to or located adjacent to the vessel 80 to function as a corrosion inhibitor shut off valve. The third flow valve 85 can be, for example, an outside screw and yoke gate valve or a control valve and is configured to be opened manually or automatically to allow corrosion inhibitor to flow into the intake line 87. Once the third flow valve 85 is opened, corrosion inhibitor from the vessel 80 can flow through the intake line 87 to the injector pump 90 and then through the reminder of the liquid piping system. Further, in embodiments, the vessel 80 can include a relief valve 95. The relief valve 95 can be, for example, an automatic spring-loaded valve or any suitable control valve and is configured to be opened manually or automatically to allow corrosion inhibitor to flow from the injector pump 90 via a loop line 97 (also referred to as a priming line) to the vessel 80. In embodiments, the relief valve 95 can be an automatic relief valve with a manual override lever or the liquid piping system 5 can include an additional bypass pipe 99 and manual relief valve 101 to provide manual override of the automatic relief valve 95. The manual relief valve 101 can be, for example, an outside screw and yoke gate valve or any control valve suitable to be opened manually to allow corrosion inhibitor to flow from the injector pump 90 via the loop line 97 and bypass pipe 99 to the vessel 80. In embodiments, the loop line 97 can be a part of the injector pump 90 and the injector pump 90 can direct any overflow of corrosion inhibitor back to the vessel 80. While the system 5 is described above as being a manual system, it can be appreciated that one or more components of the system 5 can be automated or semi-automated as discussed in more detail below.

FIG. 1A illustrates a system 7 for injecting corrosion inhibitor into a liquid piping system. The system 7 is similar to the system 5 illustrated in FIG. 1, but the system 7 utilizes a bypass injection method. In the system 7, the flow rate sensor 50, and the first check valve 45 of the system 5 are not included on the liquid pipe 20. Instead, in the system 7, a bypass line 9 connects the liquid source 30 at the connection point 11 to the mixing block 13. The connection point 11 can be located at any point upstream from the main valve 40, i.e., on the liquid source 30. In the system 7, the main valve 40 is closed during injection of the corrosion inhibitor into the system 7. The bypass line 9 can include the isolation valve 15 (similar to the isolation valve 100), the flow rate sensor 17 (similar to the flow rate sensor 50 and/or 65), the check valve 19 (similar to the check valve 45 and/or 230), and the flow valve 21 (similar to the flow valve 75, 85, and/or 101). The flow rate sensor 17, the check valve 19, and the flow valve 21 can be positioned on the bypass line 9 in any order and/or position downstream of the isolation valve 15. In embodiments, the flow valve 21 may be optional. In the system 7, the bypass line 9 and the fluid passage 60 meet at the mixing block 13. The mixing block 13 facilitates the combination of the corrosion inhibitor from the liquid passage 60 and with the liquid from the bypass line 9 before the mixture is sent to the liquid pipe 20. In the system 7, the agent flow rate sensor (e.g., the flow rate sensor 65) and agent flow valve (e.g., the flow valve 75) adjust the injection rate of corrosion inhibitor based on readings from the water flow rate sensor (e.g., the flow rate sensor 17). Once the injection process is complete, the isolation valve 15 and the isolation valve 100 allow a user to deactivate and completely isolate the corrosion inhibitor injection system from the liquid pipe 20 and the liquid source 30. Once the corrosion inhibitor injection system is isolated, a user can open the main valve 40 to resume standard system operation. Further, the corrosion inhibitor injection system of the system 7 can be removed from the liquid pipe 20 and the liquid source 30 and connected to a different liquid pipe and/or the liquid source in another location.

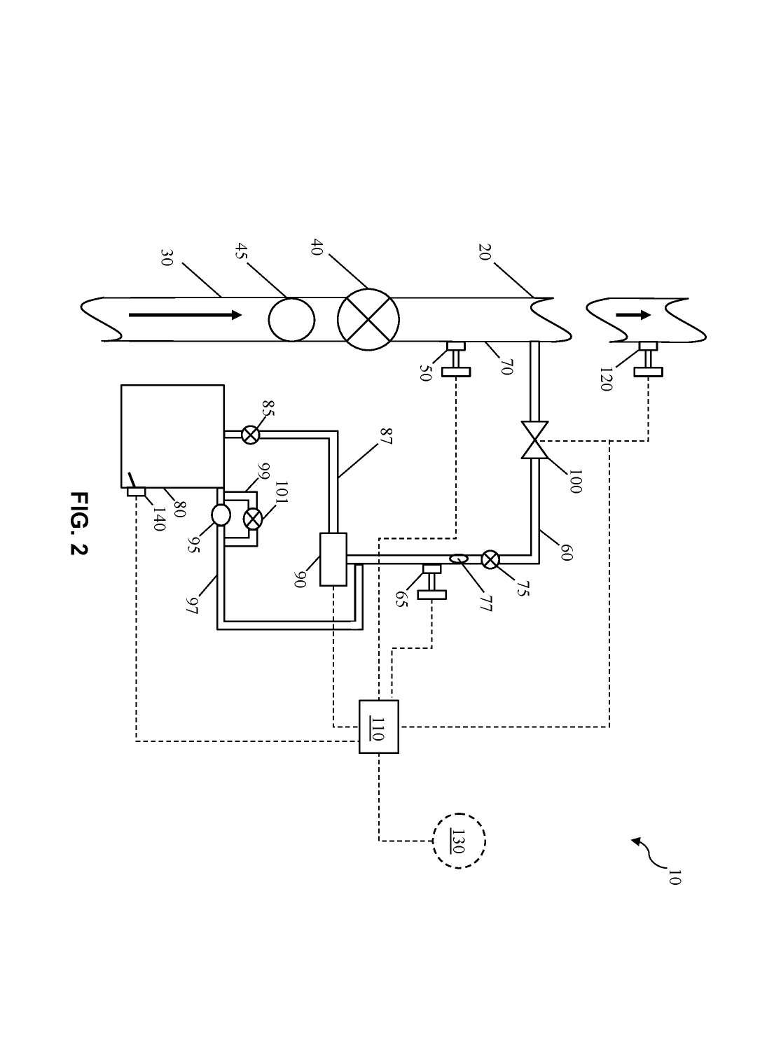

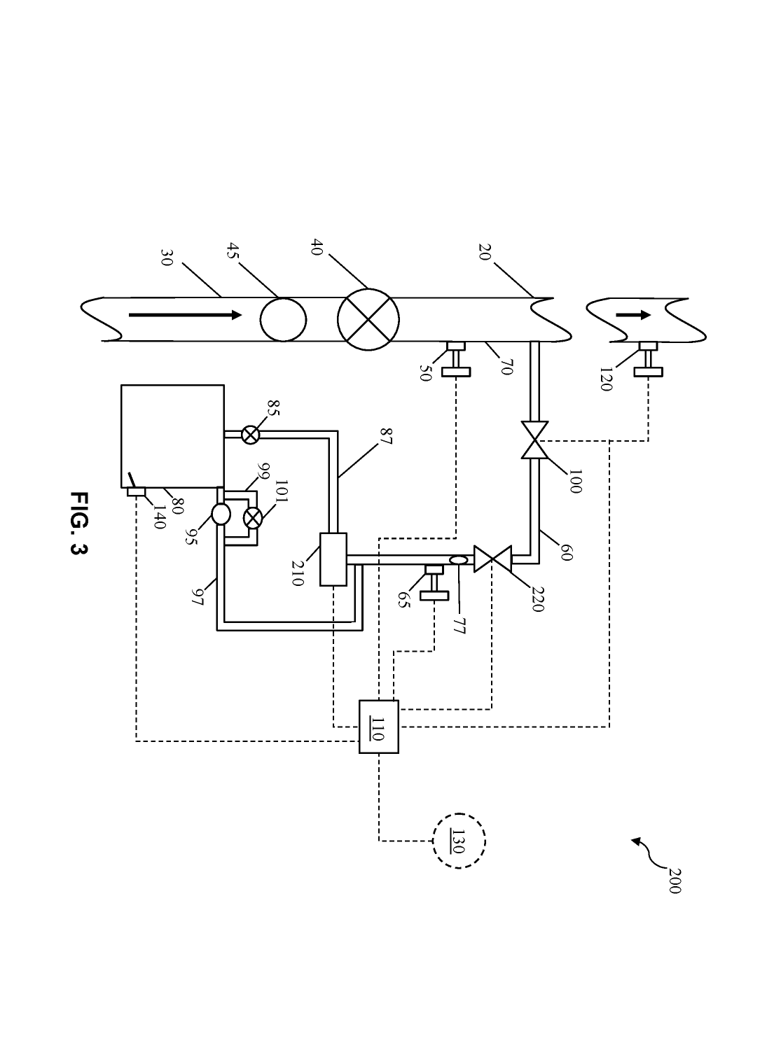

In embodiments of the system 7, a user can manually operate the isolation valve 15, the check valve 19, and/or the flow valve 21 similar to the manual operation of the various valves of the system 5. Alternatively, the check valve 19, and/or the flow valve 21 of the system 7 may operate automatically and/or semi-automatically as discussed in more detail below with reference to FIGS. 2-3. It can be appreciated that one or more additional components of the system 5 can be automated or semi-automated as discussed in more detail below with reference to the systems 10, 200, and/or 300.

FIG. 1B illustrates a system 25 for injecting corrosion inhibitor into a liquid piping system. The system 25 is similar to the system 7 illustrated in FIG. 1A, but the system 25 does not include one or more of: the check valves (e.g., the check valve 19, 45, and/or 77), the loop line 97, and/or the quantity sensor 140 of the system 5 and/or 7. Alternative embodiments of the system 25 may incorporate some or all of the omitted components (e.g., the check valve 19, 45, and/or 77), the loop line 97, and/or the quantity sensor 140 of the system 5 and /or 7) in various combinations, providing flexibility based on specific application requirements. For example, the system 25 can include the loop line 97 to facilitate pump priming of the injector pump 90 and to offer pressure relief for safety in configurations where these features are needed. As another example, the system 25 can include one or more of the check valves (e.g., the check valve 19, 45, and/or 77) to provide backflow prevention to protect the injector pump 90. In another example, the system 25 can include the quantity sensor 140 to monitor corrosion inhibitor levels and to integrate with automation systems to trigger alarms, cutoffs, and other responses when the corrosion inhibitor is depleted. While the system 27 is described above as being a manual system, it can be appreciated that one or more components of the system 25 can be automated or semi-automated as discussed in more detail below with reference to the systems 10, 200, and/or 300.

FIG. 1C illustrates a system 27 for injecting corrosion inhibitor into a liquid piping system. The system 27 illustrates a simplified version of the system 5 illustrated in FIG. 1. In the system 27, the minimum amount of components needed for injecting corrosion inhibitor into a liquid piping system are illustrated. In the system 27, a batch mixing method is used to inject the corrosion inhibitor into the liquid pipe 20. In batch mixing, corrosion inhibitor is added via the injector pump 90 to achieve a pre-determined volume. The flow rate sensor 65 measures the total volume of corrosion inhibitor in the liquid passage 60, which enables flow shutoff via the isolation valve 100 once the pre-determined volume of corrosion inhibitor is reached. Once the corrosion inhibitor has been added to the liquid pipe 20, a user opens the main valve 40 to enable the corrosion inhibitor to mix with the liquid from the liquid source 30 in the liquid pipe 20. In embodiments that use batch mixing, the liquid pipe 20 can be partially filled with liquid from the liquid source 30 before adding the corrosion inhibitor via the liquid passage 60. In yet another embodiment of batch mixing, the corrosion inhibitor can be added to the liquid pipe 20 after the liquid pipe 20 has been filled with liquid from the liquid source 30. In yet further embodiment of batch mixing, the liquid pipe 20 can be partially filled with liquid from the liquid source 30, a pre-determined volume of corrosion inhibitor can be added to the liquid pipe 20, and then the liquid pipe 20 can be filled with more liquid from the liquid source 30. In such embodiments, the addition of corrosion inhibitor from the liquid passage 60 and the addition of liquid from the liquid source 30 can be started and stopped multiple times until the liquid pipe 20 is filled. While the system 27 is described above as being a manual system, it can be appreciated that one or more components of the system 27 can be automated or semi-automated as discussed in more detail below with reference to the systems 10, 200, and/or 300.

### Semi-Automated and Fully Automated Systems for Injecting Corrosion Inhibitor

FIG. 2 illustrates a system 10 for injecting corrosion inhibitor into a liquid piping system. The system 10 is similar to the system 5 illustrated in FIG. 1, but the system 10 is a semi-automated or fully automated corrosion inhibitor injection system that includes automatic valves (e.g., the isolation valve 100) and the injector pump 90 automatically adjust to inject the corrosion inhibitor a liquid piping system. In the system 10 manual valves (e.g., the flow valve 40, the second flow valve 75, the third flow valve 85, and the relief valve 95) can be maintained as in the system 5 as an override in case automation fails and/or if any manual adjustments to the system 10 are required. The system 10 includes at least one liquid pipe 20 which can be, for example, a part of a main for a wet fire sprinkler system, cooling tower systems, boiler systems, wastewater systems, and various systems having agricultural applications. The liquid pipe 20 is connected to a liquid source 30 by a normally open flow valve 40. The valve 40 may be closed during the corrosion inhibiting mixture fill process, or other service, such as described below. The liquid source 30 can be, for example, piping connected to a commercial liquid supply. The flow valve 40 can be, for example, an outside screw and yoke gate valve or a control valve and is configured to be opened manually or automatically when the liquid piping system needs to be refilled with liquid, e.g., water. Once the flow valve 40 is opened, liquid from the liquid source 30 flows initially through the liquid pipe 20 and then through the remainder of the liquid piping system until the liquid piping system has been re-filled, and then the flow valve 40 is closed or remains open in the case of a fire sprinkler system. The system 10 includes a first check valve 45 disposed in or as part of the liquid pipe 20 to prevent a backflow of the liquid within the liquid pipe 20. The first check valve 45 can be any suitable type of check valve capable of preventing the backflow of a liquid through a pipe such as, but not limited to, a lift check valve, a piston check valve, a ball check valve, a swing check valve, a butterfly check valve, a stop check valve, a spring-loaded check valve, and/or a wafer check valve etc.

The system 10 includes a flow rate sensor 50 which is disposed in, on, or near the liquid pipe 20 and configured to determine a flow rate of liquid entering the liquid pipe 20. The flow rate sensor 50 can be, for example, but not limited to, an ultrasonic flow meter, an electromagnetic flow meter, a mechanical liquid flow meter, or a vortex volumetric flow meter, etc. Further, the flow rate sensor 50 can be, for example, but not limited to, a clamp-on flow meter that is attached to or positioned externally to the liquid pipe 20 or the flow meter that is partially or fully disposed in the liquid pipe 20. The flow rate sensor 50, while illustrated as being located downstream of the valve 40 and the check valve 45, may be located upstream of valve 40 and/or check valve 45 as long as the flow rate sensor can measure the water flow input into the system 10 in its entirety. In embodiments, the flow rate sensor 50 can include a digital display that displays the detected flow rate of the liquid entering the liquid pipe 20. The system 10 also includes a fluid passage 60 which is connected at one end to an injector pump 90, and at another end to the liquid pipe 20 at an injection point 70 which is downstream of the flow rate sensor 50. The injection point 70, while illustrated as being located downstream of the flow rate sensor 50, can be located upstream of the flow rate sensor 50. In such embodiments where the injection point 70 is upstream of the flow rate sensor 50, the calculation of corrosion inhibitor to be injected into the system 5 would be different than if the injection point 70 was located downstream of the flow rate sensor 50 because the flow rate sensor 50 would be measuring the sum total of the untreated liquid and the corrosion inhibitor. The system 10 includes a second check valve 77 disposed in or as part of the fluid passage 60 to prevent a backflow of the corrosion inhibitor or system liquid from the liquid pipe 20 within the fluid passage 60. The second check valve 77 can be any suitable type of check valve capable of preventing the backflow of a liquid through a pipe such as, but not limited to, a lift check valve, a piston check valve, a ball check valve, a swing check valve, a butterfly check valve, a stop check valve, a spring-loaded check valve, and/or a wafer check valve etc. Further, the system 10 includes an intake line 87 which is connected at one end to a vessel 80 containing a corrosion inhibitor, and at another end to the injector pump 90. The vessel 80 can be a plastic tank or any other suitable container capable of holding a sufficient amount of the corrosion inhibitor for the system 10. The corrosion inhibitor can be any liquid corrosion inhibitor for reducing the corrosion of the pipes in the liquid piping system (e.g., the system 10). Vapor Phase Corrosion Inhibitors (VCI) come in a broad range of materials including liquids, powders or embedded in packaging that protect metal surfaces from corrosion. The VCI particles travel through the air as a vapor and form a protective layer on the surface of metals which prevents oxygen, moisture and other corrosive elements from making contact with the metal surfaces. They work best in closed spaces where the particles are able to build up, such as piping systems. In a wet piping system, the VCI remains in the liquid until an air pocket, or the like where corrosion might occur, forms and the VCI becomes a vapor from the liquid. In embodiments, the corrosion inhibitor is a vapor-phase corrosion inhibitor (VCI) capable of providing direct liquid-contact corrosion prevention and vapor-phase inhibition for the liquid piping system (e.g., the system 10). The injector pump 90 (in the system 10, a variable speed injector pump) in the fluid passage 60 is configured to pump corrosion inhibitor from the vessel 80 to the injection point 70, where it is injected into the liquid pipe 20 and mixed with the liquid flowing therethrough, and its control of which is discussed in detail below. An isolation valve 100 in the fluid passage 60 downstream of the injector pump 90, e.g., the variable speed injector pump, is configured to open and close the fluid passage 60, and its control is also discussed in detail below. The injector pump 90, e.g., the variable speed injector pump, can be, for example, but not limited to, a variable speed diaphragm-type pulse injector, or a high-pressure piston dosing pump. A variable speed diaphragm-type pulse injector employs a diaphragm mechanism, which is controlled by a solenoid coil that sucks in and injects the corrosion inhibitor into the liquid pipe 20 in pulses. The time-gap between the pulses in a variable speed diaphragm-type pulse injector provides the control of the flow rate of liquid in the fluid passage 60. A high-pressure dosing pump is a mechanical piston pump that can be used as the injector pump 90, e.g., the variable speed injector pump, in systems requiring high-pressure applications. The high-pressure dosing pump can also be used as the constant speed injector pump 210 as discussed in more detail below with reference to FIG. 3. Furthermore, a second flow rate sensor 65 is provided in the fluid passage 60 to detect a flow rate of corrosion inhibitor in the fluid passage 60 and send a signal indicative of the flow rate. The system 10 can also include a second flow valve 75. The second flow valve 75 can be, for example, an outside screw and yoke gate valve or a control valve and is configured to be opened manually or automatically when corrosion inhibitor is being injected into the fluid passage 60. Once the second flow valve 75 is opened, corrosion inhibitor from the vessel 80 through the fluid passage 60 to the injection point 70 where the corrosion inhibitor mixes with the liquid flowing through the liquid pipe 20 and then through the reminder of the liquid piping system.

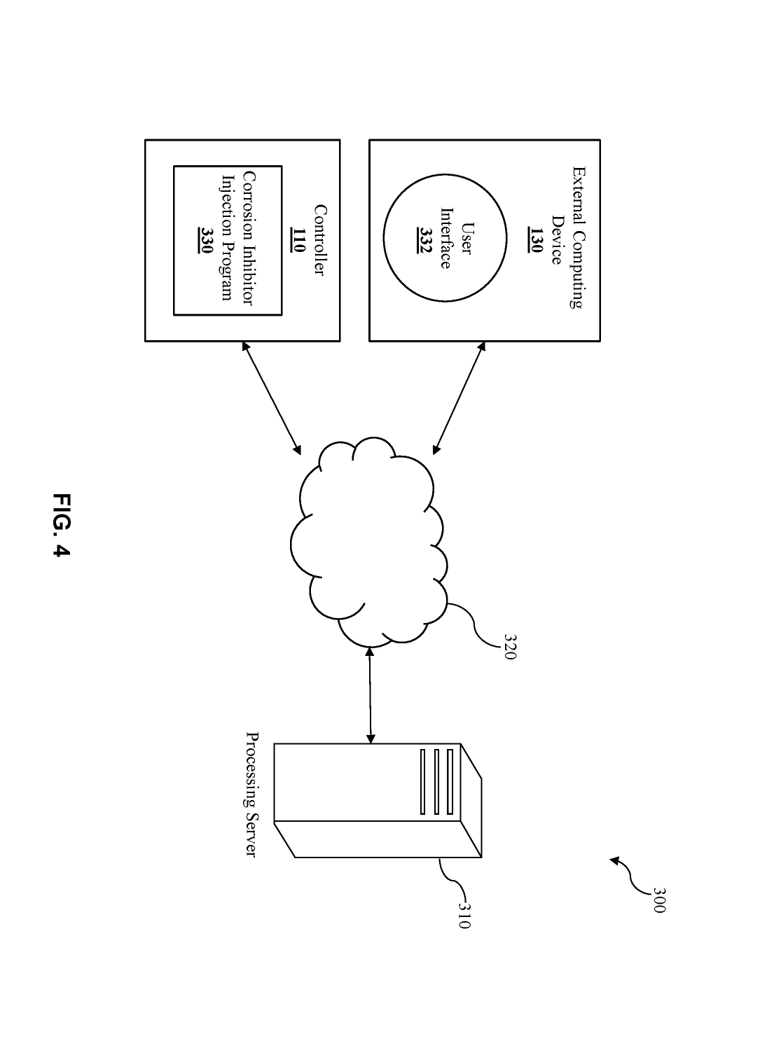

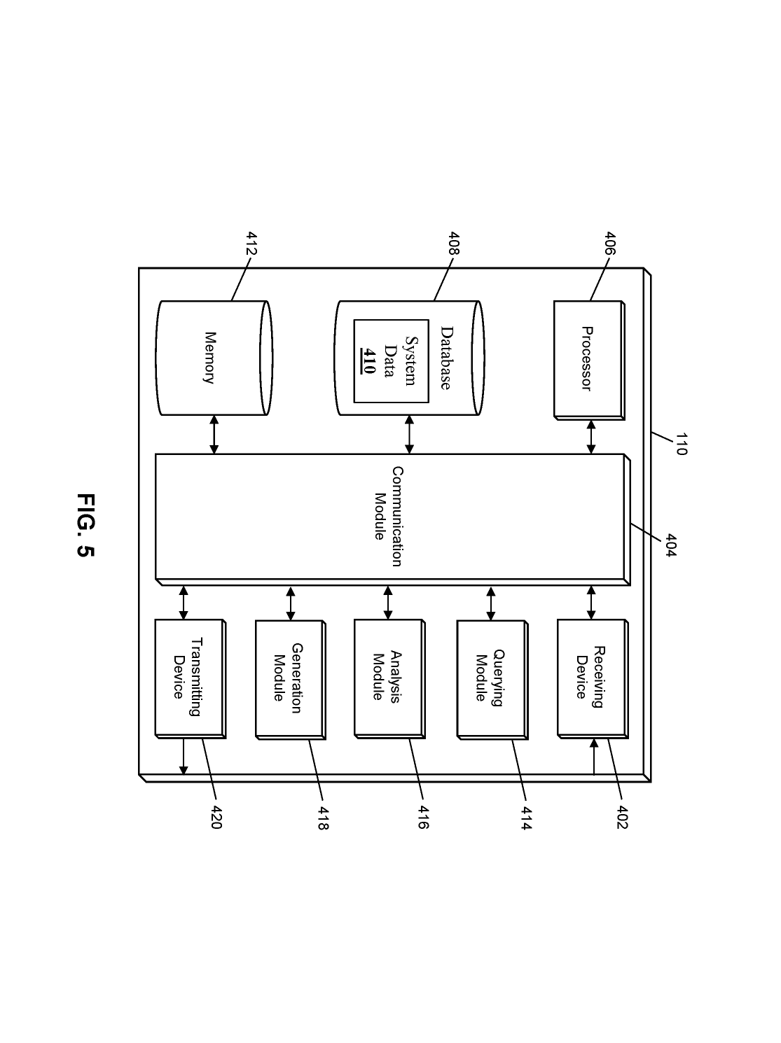

In the system 10, a controller 110 which is, for example, a programmed CPU, Application Specific Integrated Circuit (ASIC) or other dedicated circuity, is operatively connected to the flow rate sensor 50, the second flow rate sensor 65, the injector pump 90 (e.g., the variable speed injector pump), and the isolation valve 100, the concentration sensor 120, and/or the quantity sensor 140, etc. In embodiments, the controller 110 can be a computing device such as illustrated in FIGS. 4, 5, and/or 7 below. The controller 110 can communicate with the flow rate sensor 50, the second flow rate sensor 65, the injector pump 90 (e.g., the variable speed injector pump), and the isolation valve 100, the concentration sensor 120, the external computing device 130, and/or the quantity sensor 140, etc. via a network. The network can include one or more communication methods, such as radio frequency, local area networks, wireless area networks, cellular communication networks, Bluetooth, the Internet, or any other suitable communication network, etc. The flow rate sensor 50 sends a signal to the controller 110 indicative of the flow rate in the liquid pipe 20, and when it is determined that the flow rate sensor 50 detects a nonzero flow rate, the controller 110 sends a signal to the isolation valve 100 to open the isolation valve 100. Additionally, the controller 110 calculates an amount of inhibitor to inject based on the flow rate and sends a signal to the variable speed injector pump pump 90 to operate at a speed that is determined based on the calculated amount of inhibitor to inject. In an exemplary embodiment, the dosing rate of inhibitor is 0.6 to 3.2 ounces of inhibitor per one gallon of water providing a one half to two percent concentration of the inhibitor which is determined by site specific water criteria or defaults to a 1 percent dosing rate. Further, when the flow rate drops to zero, the isolation valve 100 is closed and the variable speed pump pump 90 deactivated. With this method of operation, the corrosion inhibitor can be metered into the liquid entering the liquid piping system in a precise, controlled manner. The second flow rate sensor 65 sends a signal to the controller 110 indicative of the flow rate in the fluid passage 60. In embodiments, the amount of inhibitor to inject based on the flow rate in the liquid pipe 20 can be expressed as a flow rate of corrosion inhibitor to inject into the liquid pipe 20, e.g., a flow rate of corrosion inhibitor that corresponds to a one half to two percent concentration of the corrosion inhibitor to water in the liquid pipe 20.

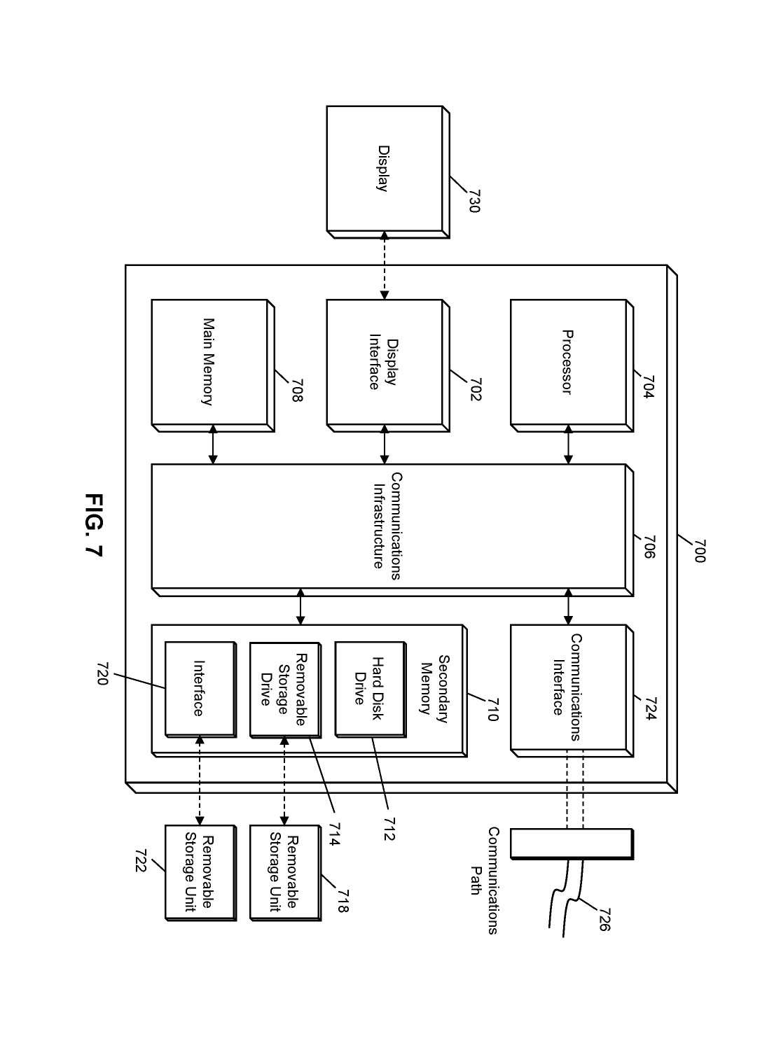

The system 10 also includes concentration sensor 120 disposed in a portion of the liquid piping system in which the corrosion inhibitor has thoroughly mixed with the liquid or other fluid, for example, significantly downstream of the injection point 70. The concentration sensor 120 sends a signal to the controller 110 indicative of the concentration of corrosion inhibitor in the liquid. If the concentration is outside a predetermined range, the controller 110 sends an alarm signal an external computing device 130, such as a BMS (Building Management System) and SMS (Security Management System), so that, for example, an voicemail, email and or text message will be sent to the appropriate personnel informing of the corrosion inhibitor concentration in the liquid falling outside the predetermined range. The external computing device 130 is discussed in more detail below with reference to FIGS. 4 and 7. Of course, there can be additional or alternative recipients of the alarm signal, such as a flashing light or other visual indicator on site or in a control room that is triggered upon receipt of the alarm signal. In response to the signal from the concentration sensor 120, the controller 110 generates and sends a signal to the injector pump 90 to increase or decrease the amount of corrosion inhibitor being injected into the liquid pipe 20. For example, if the desired concentration of corrosion inhibitor is two percent and the signal from the concentration sensor 120 indicates a concentration of one and a half percent, the controller 110 generates and sends a signal to the injector pump 90 to increase the amount of corrosion inhibitor being injected into the liquid pipe 20 until the concentration detected by the concentration sensor 120 is two percent. Of course, if too high, the amount of corrosion inhibitor could be reduced or stopped. Additionally, if an alarm is sounded, other actions such as urgently slowing or stopping the injection of corrosion inhibitor or urgently slowing or stopping the flow of liquid, or both until the issue causing the alarm is resolved.

The system 10 further includes a quantity sensor 140 (in one embodiment, a level sensor) disposed in the vessel 80 and configured to send a signal to the controller 110 indicative of the amount of corrosion inhibitor remaining in the vessel 80. If the quantity of stored corrosion inhibitor falls below a predetermined threshold, the controller 110 sends an alarm signal to the external communication device 130, so that a message will be sent the appropriate personnel informing of the quantity of stored corrosion inhibitor falling below the predetermined threshold or activating a audio and/or visual alarm. Further, if the quantity sensor 140 detects an overflow of corrosion inhibitor in the vessel 80, the quantity sensor 140 sends a signal to the controller 110 indicative of the overflow and the controller 110 can send a signal to the relief valve 95 to open to allow the overflow of the corrosion inhibitor to exit the vessel 80. The controller 110 can also send an alarm signal to the external communication device 130 indicating the detection of the overflow. In embodiments, the vessel 80 may be partially or entirely transparent such that a user can visualize the amount of corrosion inhibitor remaining in the vessel 80. In such embodiments, the vessel 80 can include graduation marks on one or more walls of the vessel 80 to aid in determining the amount of corrosion inhibitor remaining in the vessel 80. In embodiments, the system 10 can include a third flow valve 85 attached to or located adjacent to the vessel 80 to function as a corrosion inhibitor shut off valve. The third flow valve 85 can be, for example, an outside screw and yoke gate valve or a control valve and is configured to be opened manually or automatically to allow corrosion inhibitor to flow into the intake line 87. Once the third flow valve 85 is opened, corrosion inhibitor from the vessel 80 can flow through the intake line 87 to the injector pump 90 and then through the remainder of the liquid piping system. Further, in embodiments, the vessel 80 can include a relief valve 95. The relief valve 95 can be, for example, an automatic spring-loaded valve or any suitable control valve and is configured to be opened manually or automatically to allow corrosion inhibitor to flow from the injector pump 90 via a loop line 97 (also referred to as a priming line) to the vessel 80. In embodiments, the relief valve 95 can be an automatic relief valve with a manual override lever or the liquid piping system 10 can include an additional bypass pipe 99 and manual relief valve 101 to provide manual override of the automatic relief valve 95. The manual relief valve 101 can be, for example, an outside screw and yoke gate valve or any control valve suitable to be opened manually to allow corrosion inhibitor to flow from the injector pump 90 via the loop line 97 and bypass pipe 99 to the vessel 80. In embodiments, the loop line 97 can be a part of the injector pump 90 and the injector pump 90 can direct any overflow of corrosion inhibitor back to the vessel 80.The system 200 of FIG. 3 is similar to the system 10 of FIG. 2 except that, instead of using a variable speed injector pump as the injector pump 90, the corrosion inhibitor is injected with a constant speed injector pump 210 connected to a proportional control valve 220, both disposed in the fluid passage 60. The constant speed injector pump 210 can be, for example, but not limited to, a diaphragm-type constant injection pump, or a high-pressure piston dosing pump (as discussed above with reference to the variable speed injector pump pump 90). A diaphragm-type constant injection pump that includes a diaphragm, an inlet valve, an outlet valve, and a pump chamber that is filled and emptied by a piston. When the pump chamber of a diaphragm-type constant injection pump is full, the dosed volume of liquid is injected, e.g., into the fluid passage 60, at a constant flow rate, e.g., 6-250 liter/hour. Furthermore, the second flow rate sensor 65 is provided in the fluid passage 60 to detect a flow rate of corrosion inhibitor in the fluid passage 60 and send a signal indicative of the flow rate. In this embodiment, during injection of the corrosion inhibitor, the controller 110 sends a signal to activate the constant speed injector pump 210, and sends a signal to the proportional control valve 220 to open in an amount based on the calculated amount of inhibitor to inject and feedback from the second flow rate sensor 65. As discussed above, in an exemplary embodiment, the dosing rate of inhibitor is 0.6 to 3.2 ounces of inhibitor per one gallon of water providing a one half to two percent concentration of the inhibitor being injected into the fluid passage 60. The exact dosing rate is determined from site specific water sample data or defaults to a 1 percent per gallon of water dosing rate, or other liquid and dosing rate. Further, as discussed above, In embodiments, the controller 110 can be a computing device such as illustrated in FIGS. 2 and/or 7 below and the controller 110 can communicate with the second flow rate sensor 65, constant speed injector pump 210, and/or the proportional control valve 220, etc. via a network. The network can include one or more communication methods, such as radio frequency, local area networks, wireless area networks, cellular communication networks, Bluetooth, the Internet, or any other suitable communication network, etc.

### System for Injecting Corrosion Inhibitor into a Liquid Piping System

FIG. 4 illustrates a system 300 for injecting corrosion inhibitor into a liquid piping system. The system 300 can include the controller 110, the external computing device 130, and a processing server 310 communicatively coupled over the network 320. More particularly, FIG. 4 illustrates an embodiment in which the controller 110 and the external computing device 130 communicate via a software program in the system 10 and/or system 200.

As discussed above, the controller 110 can be, for example, a programmed CPU, Application Specific Integrated Circuit (ASIC) or other dedicated circuity, that is operatively connected to the flow rate sensor 50, the second flow rate sensor 65, the injector pump 90 (e.g., the variable speed injector pump), and the isolation valve 100, the concentration sensor 120, the external computing device 130, and/or the quantity sensor 140, etc. In embodiments, the controller 110 can also be communicatively connected to the processing server 310.

In embodiments, the controller 110 can include the corrosion inhibitor injection program 330 to facilitate communication with the various components of the system 10, 200, and/or 300. The corrosion inhibitor injection program 330 is a program enabling the functions of the controller 110 described herein with reference to FIGS. 2, 3, 5, and 6. For example, the corrosion inhibitor injection program 330 can include the querying module 414, the analysis module 416, and the generation module 418 as described in more detail below with reference to FIG. 5. The corrosion inhibitor injection program 330 can be, for example, a program installed on the controller 110 by a manufacturer of the controller 110, a program downloaded and installed on the controller 110 at a time of installation of the controller 110 in the systems 10, 200, and/or 300, or a web-based program hosted by a remote server, e.g., the processing server 310. It can be appreciated that in embodiments the controller 110 can execute the functions described herein without the corrosion inhibitor injection program 330.

The external computing device 130 may be a desktop computer, a notebook, a laptop computer, a tablet computer, a handheld device, a smart-phone, a thin client, a smartwatch, or any other electronic device or computing system capable of storing, compiling, and organizing audio, visual, or textual data and receiving and sending that data to and from other computing devices, such as the controller 110, and/or the processing server 310 via one or more communication methods, such as radio frequency, local area networks, wireless area networks, cellular communication networks, Bluetooth, the Internet, etc. It can be appreciated that any number of external computing devices 130 can be a part of the system 300 including a single external computing device 130 or more than one external computing device 130. The external computing device 130 may be implemented in the computer system 700 illustrated in FIG. 7 using hardware, software executed on hardware, firmware, non-transitory computer readable media having instructions stored thereon, or a combination thereof and may be implemented in one or more computer systems or other processing systems.

The external computing device 130 can include a user interface 332, for example, a graphical user interface, an application programming interface (API), a mobile application, a web page, or any other suitable user interface suitable to perform the functions discussed herein, etc. The user interface 332 can be configured to enable a user of the external computing device 130 to interact with the controller 110, e.g., via the corrosion inhibitor injection program 330. For example, the user interface 332 includes components used to receive input from a user on the external computing device 130 and transmit the input one or more other devices in the systems 10, 200, and/or 300 such as the controller 110, and/or the processing server 310, or conversely to receive information from the one or more other devices in the systems 10, 200, and/or 300 and display the information to the user on the external computing device 130. In an embodiment, the user interface 332 uses a combination of technologies and devices, such as device drivers, to provide a platform to enable users of the external computing device 130 to interact with the systems 10, 200, and/or 300, e.g., to provide a platform to enable users of the external computing device 130 to interact with the corrosion inhibitor injection program 330. In an example embodiment, the user interface 332 receives input, such as but not limited to, textual, visual, or audio input received from a physical input device, such as but not limited to, a keypad, a mouse, a camera, and/or a microphone, etc. As an example, a user on the external computing device 130 can, via the user interface 332, can send instructions to the controller 110. Further, the user interface 332 can be configured to display data to a user on the external computing device 130 such as one or more notifications from the controller 110 as described in more detail with reference to FIGS. 2, 3, 5 and 6.

The processing server 310 may be a desktop computer, a notebook, a laptop computer, a tablet computer, a handheld device, a smart-phone, a thin client, a smartwatch, or any other electronic device or computing system capable of storing, compiling, and organizing audio, visual, or textual data and receiving and sending that data to and from other computing devices, such as the controller 110, the and/or the external computing device 130 via one or more communication methods, such as radio frequency, local area networks, wireless area networks, cellular communication networks, Bluetooth, the Internet, etc. In an embodiment, the processing server 310 may be manufacturer, retailer, distributor, wholesaler, servicer, manager, etc. of the controller 110. For example, the processing server 310 may be associated with a software manager for the corrosion inhibitor injection program 330 installed on the controller 110. In such embodiments, the processing server 310 may set parameter defaults, issue software updates, verify/validate the controller 110 and/or the external computing device 130 (e.g., verify the controller 110 as being authentic, verify the external computing device as being authorized for communication with the controller 110, etc.), act as an intermediary for communications between the controller 110 and the external computing device 130, provide backup for the controller 110, etc. In embodiments, the processing server 310 may provide third-party control of the controller 110 on behalf of a user of the systems 10, 200, and/or 300. In such embodiments, it can be appreciated that the processing server 310 and the external computing device 130 can be a single device. The processing server 310 may be implemented in the computer system 700 illustrated in FIG. 7 using hardware, software executed on hardware, firmware, non-transitory computer readable media having instructions stored thereon, or a combination thereof and may be implemented in one or more computer systems or other processing systems. The network 320 can be any suitable communication network that enables communication between the devices of the system 300 such as the controller 110, the external computing device 130, and/or the processing server 310. For example, the network 320 can be, but is not limited to, a wired connection, a wireless network (e.g., WiFi), a mobile communication network, a satellite network, the Internet, fiber optic, coaxial cable, infrared, radio frequency (RF), or any combination thereof. Other suitable network types and configurations for the network 320 will be apparent to persons having skill in the relevant art.

### Controller

FIG. 5 illustrates an example controller 110 in the system 10, system 200, and/or the system 300. It will be apparent to persons having skill in the relevant art that the embodiment of the controller 110 illustrated in FIG. 5 is provided as illustration only and is not exhaustive of all possible configurations of the controller 110 suitable for performing the functions as discussed herein. For example, the computer system 700 illustrated in FIG. 7 and discussed in more detail below can be a suitable configuration of the controller 110.

The controller 110 can include a receiving device 402. The receiving device 402 can be configured to receive data over one or more networks via one or more network protocols. In some instances, the receiving device 402 can be configured to receive data from the flow rate sensor 50, the second flow rate sensor 65, the injector pump 90 (e.g., the variable speed injector pump), the isolation valve 100, the concentration sensor 120, the external computing device 130, the quantity sensor 140, the constant speed injector pump 210, the proportional control valve 220, the processing server 310 and other systems and entities via one or more communication methods, such as radio frequency, local area networks, wireless area networks, cellular communication networks, Bluetooth, the Internet, etc. In some embodiments, the receiving device 402 can be comprised of multiple devices, such as different receiving devices for receiving data over different networks, such as a first receiving device for receiving data over a local area network and a second receiving device for receiving data via the Internet. The receiving device 402 can receive electronically transmitted data signals, where data can be superimposed or otherwise encoded on the data signal and decoded, parsed, read, or otherwise obtained via receipt of the data signal by the receiving device 402. In some instances, the receiving device 402 can include a parsing module for parsing the received data signal to obtain the data superimposed thereon. For example, the receiving device 402 can include a parser program configured to receive and transform the received data signal into usable input for the functions performed by the controller 110 to carry out the methods and systems described herein.

The receiving device 402 can be configured to receive data signals electronically transmitted by the flow rate sensor 50 indicating the flow rate in the liquid pipe 20 and the receiving device 402 can be configured to receive data signals electronically transmitted by the second flow rate sensor 65 that are superimposed or otherwise encoded with data indicating the flow rate in the fluid passage 60. The receiving device 402 can also be configured to receive data signals electronically transmitted by the injector pump 90 (e.g., the variable speed injector pump) that are superimposed or otherwise encoded with data indicating a pumping speed/rate of the injector pump 90, a status of the injector pump 90 (e.g., on, off, idle, standby, disabled, etc.). The receiving device 402 can also be configured to receive data signals electronically transmitted by the isolation valve 100 and/or the proportional control valve 220 that are superimposed or otherwise encoded with data indicating a status of the isolation valve 100 and/or the proportional control valve 220 (e.g., open or closed, etc.). The receiving device 402 can also be configured to receive data signals electronically transmitted by the concentration sensor 120 that are superimposed or otherwise encoded with data indicating the concentration of corrosion inhibitor in the liquid. The receiving device 402 can also be configured to receive data signals electronically transmitted by the external computing device 130 that are superimposed or otherwise encoded with system control requests. The receiving device 402 can also be configured to receive data signals electronically transmitted by the processing server 310 that are superimposed or otherwise encoded with system control requests, software updates, etc. The receiving device 402 can also be configured to receive data signals electronically transmitted by the quantity sensor 140 that are superimposed or otherwise encoded with data indicating the amount and/or level of corrosion inhibitor remaining in the vessel 80. The receiving device 402 can also be configured to receive data signals electronically transmitted by the injector pump 90 (e.g., the variable speed injector pump) that are superimposed or otherwise encoded with data indicating a pumping speed/rate of the constant speed injector pump 210, a status of the constant speed injector pump 210 (e.g., on, off, idle, standby, disabled, etc.).

The controller 110 can also include a communication module 404. The communication module 404 can be configured to transmit data between modules, engines, databases, memories, and other components of the controller 110 for use in performing the functions discussed herein. The communication module 404 can be comprised of one or more communication types and utilize various communication methods for communications within a computing device. For example, the communication module 404 can be comprised of a bus, contact pin connectors, wires, etc. In some embodiments, the communication module 404 can also be configured to communicate between internal components of the controller 110 and external components of the controller 110, such as externally connected databases, display devices, input devices, etc. The controller 110 can also include a processor 406. The processor 406 can be configured to perform the functions of the controller 110 discussed herein as will be apparent to persons having skill in the relevant art. In some embodiments, the processor 406 can include and/or be comprised of a plurality of engines and/or modules specially configured to perform one or more functions of the processor 406, such as the querying module 414, the analysis module 416, and the generation module 418, etc. As used herein, the term “module” can be software or hardware particularly programmed to receive an input, perform one or more processes using the input, and provides an output. The input, output, and processes performed by various modules will be apparent to one skilled in the art based upon the present disclosure.

The controller 110 can also include the database 408. The database 408 can be configured to store system data 410 using a suitable data storage format and schema. The database 408 can be a relational database that utilizes structured query language for the storage, identification, modifying, updating, accessing, etc. of structured data sets stored therein. The system data 410 can be a structured data set configured to store data related to a particular property in which the systems disclosed herein are located. The system data 410 can include, for example, a property name, a property location, a property size, a defined corrosion inhibitor concentration for the liquid piping systems (e.g., the systems 5, 10, and 200, etc.) located on and/in the property, one or more operating parameters for the liquid piping systems (e.g., the systems 5, 10, and 200, etc.) located on and/in the property, a maintenance schedule for the liquid piping systems (e.g., the systems 5, 10, and 200, etc.) located on and/in the property, etc. In some embodiments, the database 408 can be a lookup table that can be accessed by the controller 110 and one or more systems external to the controller 110, such as external computing device 130, and the processing server 310, etc.

The controller 110 can also include a memory 412. The memory 412 can be configured to store data for use by the controller 110 in performing the functions discussed herein. The memory 412 can be configured to store data using suitable data formatting methods and schema and can be any suitable type of memory, such as read-only memory, random access memory, etc. The memory 412 can include, for example, communication protocols and standards, data formatting standards and protocols, program code for modules and application programs of the controller 110, and other data that can be suitable for use by the controller 110 in the performance of the functions disclosed herein as will be apparent to persons having skill in the relevant art. In some embodiments, the memory 412 can be comprised of or can otherwise include a relational database that utilizes structured query language for the storage, identification, modifying, updating, accessing, etc. of structured data sets stored therein. The memory 412 can be configured to store the system data 410.

The controller 110 can include a querying module 414. The querying module 414 can be configured to execute queries on databases to identify information. The querying module 414 can receive one or more data values or query strings and can execute a query string based thereon on an indicated database, such as the database 408 of the controller 110 to identify information stored therein. The querying module 414 can then output the identified information to an appropriate engine or module of the controller 110 as necessary. The querying module 414 can, for example, execute a query on the database 408 to identify the desired concentration level of corrosion inhibitor included in the system data 410 for the systems 5, 10, and/or 200.

The controller 110 can also include an analysis module 416. The analysis module 416 can be configured to analyze data for use by the controller 110 in performing the functions discussed herein. The analysis module 416 can utilize the data received from the flow rate sensor 50, the second flow rate sensor 65, the injector pump 90 (e.g., the variable speed injector pump), the isolation valve 100, the concentration sensor 120, the external computing device 130, the quantity sensor 140, the constant speed injector pump 210, the proportional control valve 220, and other systems and entities, as input and process the data for use by the controller 110. For example, the analysis module 416 can receive data from the flow rate sensor 50 indicating the flow rate of liquid entering the liquid pipe 20 to determine a flow rate of corrosion inhibitor to inject into the liquid pipe 20 at the injection point 70. The analysis module 416 can receive data from the second flow rate sensor 65 indicating the flow rate of corrosion inhibitor through the fluid passage 60 and determine if the flow rate should be increased or decreased based on the desired concentration of corrosion inhibitor in the liquid piping system. The analysis module 416 can also use data from the concentration sensor 120 and/or the proportional control valve 220 in determining whether the flow rate of corrosion inhibitor should be increased or decreased based on the desired concentration of corrosion inhibitor in the liquid piping system. The analysis module 416 can receive data from the quantity sensor 140 indicating that the level of corrosion inhibitor and determine when the isolation valve 100 should be closed and when the injector pump 90 and/or the constant speed injector pump 210 should be shut down.

The controller 110 can also include a generation module 418. The generation module 418 can be configured to generate data for use by the controller 110 in performing the functions discussed herein. The generation module 418 can receive instructions as input, can generate data based on the instructions, and can output the generated data to one or more modules of the controller 110. The generation module 418 can be configured to generate signals to the flow sensor 50, the second control sensor 65, injector pump 90, the isolation valve 100, the concentration sensor 120, the external computing device 130, the quantity sensor 140, the constant speed injector pump 210, and/or the proportional control valve 220. For example, the generation module 418 can generate a signal to the injector pump 90 and/or the constant speed injector pump 210 to operate at a speed that is determined based on the calculated amount of corrosion inhibitor to inject, e.g., based on the desired concentration of corrosion inhibitor in the liquid piping system. The generation module 418 can generate a signal to the external computing device 130 such as a voicemail, an email, a text message, an alert notification, or any other suitable alert, etc. The signal to the external computing device can, for example, a warning that a concentration of the corrosion inhibitor is outside a desired range, an indication of a quantity of corrosion inhibitor in the vessel 80 (e.g., in response to a signal received from the quantity sensor 140), a notification indicating a status of the system 10 and/or 200 (e.g., on/off status, a percent completion of system fill, an error message indicating an issue with the system 10 and/or 200, etc.). In response to a signal from the concentration sensor 120, the generation module 418 can generate a signal to the injector pump 90 to increase or decrease the amount of corrosion inhibitor being injected into the liquid pipe 20. The generation module 418 can generate a signal to the relief valve 95 to open to allow the overflow of the corrosion inhibitor to exit the vessel 80. The generation module 418 can generate a signal to the isolation valve 100 to open the isolation valve 100, e.g., in response to receiving a signal from the flow rate sensor 50 indicating a nonzero flow rate. In the system 200, the generation module 418 can generate a signal to activate the constant speed injector pump 210 and a signal to the proportional control valve 220 to open in an amount based on the calculated amount of inhibitor to inject and feedback from the second flow rate sensor 65. Further, the generation module 418 can generate the system data 410 in response to data received from the external computing device 130 and/or the processing server 310.

The controller 110 can also include a transmitting device 420. The transmitting device 420 can be configured to transmit data over one or more networks via one or more network protocols. In some instances, the transmitting device 420 can be configured to transmit data to the flow rate sensor 50, the second flow rate sensor 65, the injector pump 90 (e.g., the variable speed injector pump), the isolation valve 100, the concentration sensor 120, the external computing device 130, the quantity sensor 140, the constant speed injector pump 210, the proportional control valve 220, the processing server 310, and other entities via one or more communication methods, local area networks, wireless area networks, cellular communication, Bluetooth, radio frequency, the Internet, etc. In some embodiments, the transmitting device 420 can be comprised of multiple devices, such as different transmitting devices for transmitting data over different networks, such as a first transmitting device for transmitting data over a local area network and a second transmitting device for transmitting data via the Internet. The transmitting device 420 can electronically transmit data signals that have data superimposed that can be parsed by a receiving computing device. In some instances, the transmitting device 420 can include one or more modules for superimposing, encoding, or otherwise formatting data into data signals suitable for transmission.

The transmitting device 420 can be configured to electronically transmit data signals to the flow rate sensor 50, the second flow rate sensor 65, the injector pump 90 (e.g., the variable speed injector pump), the isolation valve 100, the concentration sensor 120, the external computing device 130, the quantity sensor 140, the constant speed injector pump 210, the proportional control valve 220, etc. that are superimposed or otherwise encoded with the signal generated by the generation module 418.

The corrosion injection systems 5, 7, 10, 25, 27, 200, and 300 can be permanently installed in the liquid piping system, or can be a portable system having quick connect/disconnect connections at the flow sensor, injection point, and concentration sensor. Such a portable system can, for example, be arranged on a cart of other mobile platform and taken to different sites as needed and connected to the piping system and an electrical power source.

### Method for Manual for Injection of Corrosion Inhibitor into a Liquid Piping System

In a method using systems according to the present application, the flow valve 40 is opened as needed to replenish the liquid piping system. During this replenishment, the injector (e.g., the variable speed injector pump 90 and/or the constant speed injector pump 210 and proportional control valve 220) is controlled to automatically inject corrosion inhibitor into the flow of liquid into the liquid piping system, based on the flow rate detected by the flow rate sensor 50, and the injection is ended when liquid stops flowing into the system. Furthermore, external alarms are generated and sent when the concentration of corrosion inhibitor in the system is outside a predetermined range, or when the amount of corrosion inhibitor available for injection falls below a predetermined threshold. The corrosion inhibitor can thus be precisely, automatically added as-needed, along with remote monitoring and notification.

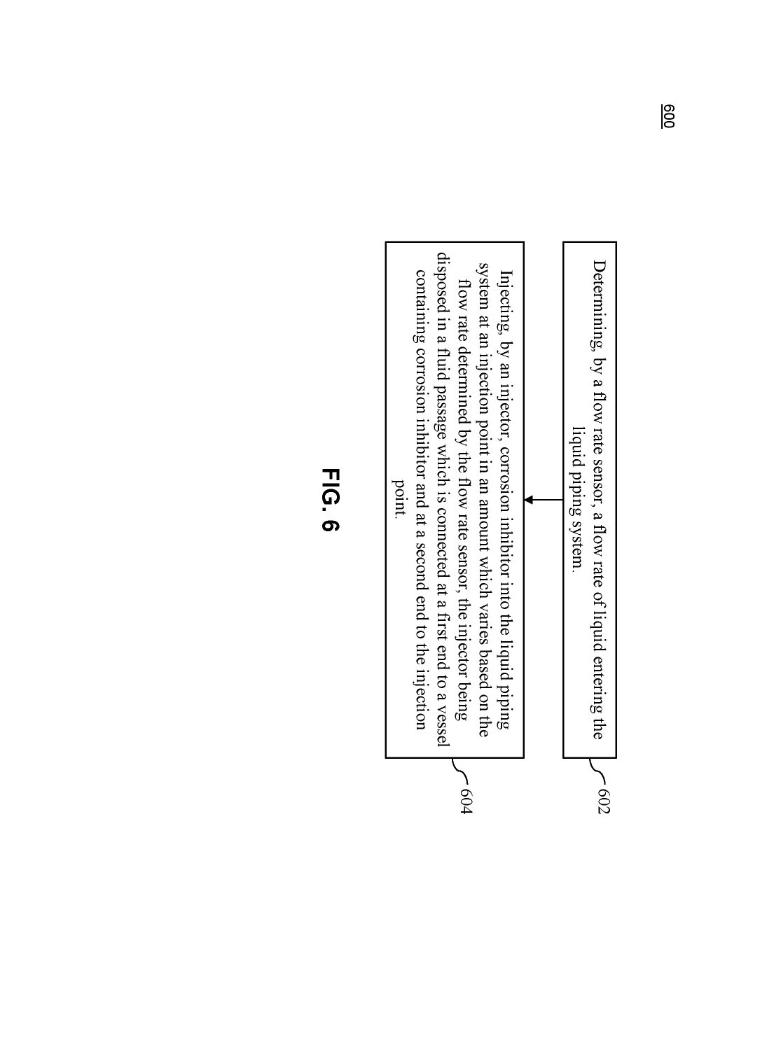

FIG. 6 illustrates a method 600 for injecting corrosion inhibitor into a liquid piping system in the system 5, 7, 10, 25, 27, 200, and/or 300.

In step 602, a flow rate sensor (e.g., the flow rate sensor 50) determines a flow rate of liquid entering the liquid piping system (e.g., the system 5, 7, 10, 25, 27, 200, and/or 300).

Prior to the step 602, the vessel 80 is filled with a prescribed amount of corrosion inhibitor. For example, a customer may be provided with a prescribed amount of corrosion inhibitor based on the size of the liquid piping system in the systems 5, 10, 200, and/or 300. Once the vessel 80 has been filled with the corrosion inhibitor, the injector (e.g., the injector pump 90 and/or the constant speed injector pump 210) is turned on and the relief valve 95 is opened so that the corrosion inhibitor fills the loop line 97. Once the loop line 97 has been filled, the relief valve 95 can be closed. Further, in embodiments, prior to the step 602, the flow rate sensors (e.g., the first flow rate sensor 50 and/or the second flow rate sensor 65) should be zeroed out. The corrosion inhibitor can be any liquid corrosion inhibitor for reducing the corrosion of the pipes in the liquid piping system (e.g., the systems 5, 7, 10, 25, 27, 200, and/or 300). In embodiments, the corrosion inhibitor is a vapor-phase corrosion inhibitor (VCI) capable of providing direct liquid-contact corrosion prevention and vapor-phase inhibition for the liquid piping system (e.g., the systems 5, 7, 10, 25, 27, 200, and/or 300).

In step 604, an injector injects corrosion inhibitor into the liquid piping system at an injection point (e.g., the injection point 70) in an amount which varies based on the flow rate determined by the flow rate sensor (e.g., the flow rate sensor 50). The injector being disposed in a fluid passage (e.g., the fluid passage 60) which is connected at a first end to a vessel (e.g., the vessel 80) containing corrosion inhibitor and at a second end to the injection point (e.g., the injection point 70). The amount of corrosion inhibitor injected into the liquid piping system (e.g., the system 5, 7, 10, 25, 27, 200, and/or 300) by the injector is an amount of corrosion inhibitor required to maintain a predetermined concentration of corrosion inhibitor in the liquid of the liquid piping system (e.g., the system 5, 7, 10, 25, 27, 200, and/or 300). In embodiments, the predetermined concentration of corrosion inhibitor in the liquid of the liquid piping system (e.g., the system 5, 10, and/or 200) is between 0.1 percent and 6 percent based on a total volume of liquid in the liquid piping system (e.g., the system 5, 7, 10, 25, 27, 200, and/or 300). In embodiments, the injector injects the corrosion inhibitor into the liquid piping system (e.g., the system 5, 7, 10, 25, 27, 200, and/or 300) at a controlled rate to cause an even distribution of corrosion inhibitor in the liquid of the liquid piping system (e.g., the system 5, 7, 10, 25, 27, 200, and/or 300). In the system 5 and/or the system 10, the injector (e.g., the injector pump 90) is a variable speed injection pump disposed in the fluid passage (e.g., the fluid passage 60). In the system 5 and/or the system 200, the injector is a constant speed injection pump (e.g., constant speed injector pump 210) disposed in the fluid passage (e.g., the fluid passage 60) and a proportional valve (e.g., the proportional valve 220) disposed in the fluid passage (e.g., the fluid passage 60) downstream of the constant speed injection pump (e.g., constant speed injector pump 210). Once all the corrosion inhibitor has been injected into the liquid piping system, the control valve 75 is closed and the injector (e.g., the injector pump 90 and/or the constant speed injector pump 210) is turned off.

The systems 5, 7, 10, 25, 27, and/or 200 can further include a second flow rate sensor (e.g. second flow rate sensor 65) to detect a flow rate of corrosion inhibitor in the fluid passage (e.g., the fluid passage 60). In embodiments including the second flow rate sensor 65, the amount of corrosion inhibitor injected into the liquid piping system can be determined by matching the flow rate detected by the first flow rate sensor 50 with the flow rate detected by the sensor 65. For example, the control valve 40 and the control 75 can be adjusted until the flow rates detected by the first flow rate sensor 50 and the second flow rate sensor 65 match. The injection point (e.g., the injection point 70) includes a mixing block that mixes the corrosion inhibitor with the liquid of the liquid piping system (e.g., the system 5, 7, 10, 25, 27, and/or 200).

The method 600 can further include a concentration sensor (e.g., the concentration sensor 120) detecting a concentration of corrosion inhibitor in the liquid in the liquid piping system (e.g., the system 5, 10, and/or 200). The concentration sensor (e.g., the concentration sensor 120) can generate an alarm signal if the concentration determined by the concentration sensor (e.g., the concentration sensor 120) is outside a predetermined range.

The method 600 can further include a quantity sensor (e.g., the quantity sensor 140) determining a quantity of corrosion inhibitor in the vessel (e.g., the vessel 80). The quantity sensor (e.g., the quantity sensor 140) can generate an alarm signal if the quantity of corrosion inhibitor determined by the quantity sensor (e.g., the quantity sensor 140) is below a predetermined quantity.

The method 600 can further include a controller (e.g., the controller 110) operatively coupled to the flow rate sensor (e.g., the flow rate sensor 50) and the injector (e.g., the injector pump 90 and/or the constant speed injector 210). In such embodiments, the controller (e.g., the controller 110) receives a first signal including the flow rate of the liquid entering the liquid piping system (e.g., the system 5, 7, 10, 25, 27, and/or 200) from the flow rate sensor (e.g., the flow rate sensor 50). The controller (e.g., the controller 110) determines a concentration of the corrosion inhibitor to inject into the liquid piping system (e.g., the system 5, 10, and/or 200) based on the flow rate of the liquid entering the liquid piping system (e.g., the system 5, 7, 10, 25, 27, and/or 200). The controller (e.g., the controller 110) can determine a rate of injection of the corrosion inhibitor based on the flow rate of the liquid entering the liquid piping system (e.g., the system 5, 7, 10, 25, 27, and/or 200) and the determined concentration. The controller (e.g., the controller 110) can generate a second signal instructing the injector (e.g., the injector pump 90 and/or the constant speed injector pump 210) to inject the corrosion inhibitor into the liquid piping system (e.g., the system 5, 7, 10, 25, 27, and/or 200) at the determined rate of injection. The controller (e.g., the controller 110) can transmit the second signal to the injector (e.g., the injector pump 90 and/or the constant speed injector pump 210)

In embodiments, the method 600 can further include the controller (e.g., the controller 110) receiving, from a concentration sensor (e.g., the concentration sensor 120), a concentration notification indicating a concentration of corrosion inhibitor in the liquid in the liquid piping system (e.g., the system 5, 7, 10, 25, 27, and/or 200). the concentration sensor (e.g., the concentration sensor 120) is located at a position in the liquid piping system (e.g., the system 5, 7, 10, 25, 27, and/or 200) downstream of the injection point (e.g. the injection point 70). If the controller (e.g., the controller 110) determines the concentration of corrosion inhibitor in the liquid in the liquid piping system (e.g., the system 5, 7, 10, 25, 27, and/or 200) indicated by the concentration sensor (e.g., the concentration sensor 120) is outside a predetermined range, the controller (e.g., the controller 110) generates a third signal indicating the concentration of corrosion inhibitor in the liquid in the liquid piping system (e.g., the system 5, 7, 10, 25, 27, and/or 200) is outside the predetermined range, and the controller (e.g., the controller 110) electronically transmits the third signal to an external computing device (e.g., the external computing device 130 and/or the processing server 310). The third signal can be one or more of, for example, a text message, an e-mail, an application notification message, and an audio message.

In embodiments, the method 600 can further include the controller (e.g., the controller 110) operatively coupled to the flow rate sensor (e.g., the flow rate sensor 50) and the injector (e.g. the injector pump 90 and/or the constant speed injector pump 210). The controller (e.g., the controller 110) receives, from a quantity sensor (e.g. the quantity sensor 140) located on the vessel (e.g., the vessel 80), a quantity notification indicating a quantity of corrosion inhibitor in the vessel (e.g. the vessel 80) is below a predetermined quantity. The controller (e.g., the controller 110) generates a signal indicating the quantity of corrosion inhibitor in the vessel (e.g., the vessel 80) is below the predetermined quantity, and the controller (e.g., the controller 110) electronically transmits the generated signal to an external computing device (e.g., the external computing device 130 and/or the processing server 310. The signal can be one or more of, for example, a text message, an e-mail, an application notification message, and an audio message.

### Computer System Architecture

FIG. 7 illustrates a computer system 700 in which embodiments of the present disclosure, or portions thereof, can be implemented as computer-readable code. For example, the controller 110, the external computing device 130, and/or the processing server 310 can be implemented in the computer system 700 using hardware, non-transitory computer readable media having instructions stored thereon, or a combination thereof and can be implemented in one or more computer systems or other processing systems. Hardware can embody modules and components used to implement the methods of FIG. 6.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, at least one processor device and a memory can be used to implement the above-described embodiments.

A processor unit or device as discussed herein can be a single processor, a plurality of processors, or combinations thereof. Processor devices can have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 704 can be a special purpose or a general-purpose processor device specifically configured to perform the functions discussed herein. The processor device 704 can be connected to a communications infrastructure 706, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 can also include a main memory 708 (e.g., random access memory, read-only memory, etc.), and can also include a secondary memory 710. The secondary memory 710 can include the hard disk drive 712 and a removable storage drive 714, such as a floppy disk drive, a magnetic tape drive, an optical disk drive, a flash memory, etc.

The removable storage drive 714 can read from and/or write to the removable storage unit 718 in a well-known manner. The removable storage unit 718 can include a removable storage media that can be read by and written to by the removable storage drive 714. For example, if the removable storage drive 714 is a floppy disk drive or universal serial bus port, the removable storage unit 718 can be a floppy disk or portable flash drive, respectively. In one embodiment, the removable storage unit 718 can be non-transitory computer readable recording media.

In some embodiments, the secondary memory 710 can include alternative means for allowing computer programs or other instructions to be loaded into the computer system 700, for example, the removable storage unit 722 and an interface 720. Examples of such means can include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to persons having skill in the relevant art.

The computer system 700 can also include a communications interface 724. The communications interface 724 can be configured to allow software and data to be transferred between the computer system 700 and external devices. Exemplary communications interfaces 724 can include a modem, a network interface (e.g., an Ethernet card), a communications port, a PCMCIA slot and card, etc. Software and data transferred via the communications interface 724 can be in the form of signals, which can be electronic, electromagnetic, optical, or other signals as will be apparent to persons having skill in the relevant art. The signals can travel via a communications path 726, which can be configured to carry the signals and can be implemented using wire, cable, fiber optics, a phone line, a cellular phone link, a radio frequency link, etc.

The computer system 700 can further include a display interface 702. The display interface 702 can be configured to allow data to be transferred between the computer system 700 and external display 730. Exemplary display interfaces 702 can include high-definition multimedia interface (HDMI), digital visual interface (DVI), video graphics array (VGA), etc. The display 730 can be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium can refer to memories, such as the main memory 708 and secondary memory 710, which can be memory semiconductors (e.g., DRAMs, etc.). These computer program products can be means for providing software to the computer system 700. Computer programs (e.g., computer control logic) can be stored in the main memory 708 and/or the secondary memory 710. Computer programs can also be received via the communications interface 724. Such computer programs, when executed, can enable computer system 700 to implement the present methods as discussed herein. In particular, the computer programs, when executed, can enable processor device 504 to implement the methods illustrated by FIG. 6, as discussed herein. Accordingly, such computer programs can represent controllers of the computer system 700. Where the present disclosure is implemented using software, the software can be stored in a computer program product and loaded into the computer system 700 using the removable storage drive 714, interface 720, and hard disk drive 712, or communications interface 724.

The processor device 704 can comprise one or more modules or engines configured to perform the functions of the computer system 700. Each of the modules or engines can be implemented using hardware and, in some instances, can also utilize software, such as corresponding to program code and/or programs stored in the main memory 708 or secondary memory 710. In such instances, program code can be compiled by the processor device 704 (e.g., by a compiling module or engine) prior to execution by the hardware of the computer system 700. For example, the program code can be source code written in a programming language that is translated into a lower-level language, such as assembly language or machine code, for execution by the processor device 704 and/or any additional hardware components of the computer system 700. The process of compiling can include the use of lexical analysis, preprocessing, parsing, semantic analysis, syntax-directed translation, code generation, code optimization, and any other techniques that can be suitable for translation of program code into a lower-level language suitable for controlling the computer system 700 to perform the functions disclosed herein. It will be apparent to persons having skill in the relevant art that such processes result in the computer system 700 being a specially configured computer system 700 uniquely programmed to perform the functions discussed above.

Techniques consistent with the present disclosure provide, among other features, systems and methods for injecting corrosion inhibitor into liquid piping systems. While various exemplary embodiments of the disclosed system and method have been described above it should be understood that they have been presented for purposes of example only, not limitations. For instance, various embodiments of the disclosed injector systems can be fully isolatable from the systems they are installed on to, e.g., ensure they do not interfere with the normal operation of those systems. This also means that they are removeable and transportable, so a single injector system can be used to protect multiple fluid pipe systems. Hence, this disclosure is not exhaustive and does not limit the disclosure to the precise form disclosed. Modifications and variations are possible in light of the above teachings or can be acquired from practicing of the disclosure, without departing from the breadth or scope.

It will be appreciated by those skilled in the art that the disclosure herein can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A system for injecting corrosion inhibitor into a liquid piping system, comprising:
a flow rate sensor configured to determine a flow rate of liquid entering the liquid piping system; and
an injector configured to inject corrosion inhibitor into the liquid piping system at an injection point in an amount which varies based on the flow rate determined by the flow rate sensor, the injector being disposed in a fluid passage which is connected at a first end to a vessel containing corrosion inhibitor and at a second end to the injection point.

2. The system of claim 1, wherein the amount of corrosion inhibitor injected into the liquid piping system by the injector is an amount of corrosion inhibitor required to maintain a predetermined concentration of corrosion inhibitor in the liquid of the liquid piping system.

3. The system of claim 2, wherein the predetermined concentration of corrosion inhibitor in the liquid of the liquid piping system is between 0.1 percent and 6 percent based on a total volume of liquid in the liquid piping system.

4. The system of claim 1, wherein the injector injects the corrosion inhibitor into the liquid piping system at a controlled rate, the controlled rate causing an even distribution of corrosion inhibitor in the liquid of the liquid piping system.

5. The system of claim 1, further comprising:
a concentration sensor configured to determine a concentration of corrosion inhibitor in the liquid in the liquid piping system; and
an alarm which generates an alarm signal if the concentration determined by the concentration sensor is outside a predetermined range.

6. The system of claim 1, further comprising:
a quantity sensor configured to determine a quantity of corrosion inhibitor in the vessel; and
an alarm which generates an alarm signal if the quantity of corrosion inhibitor determined by the quantity sensor is below a predetermined quantity.

7. The system of claim 1, wherein the injector comprises a variable speed injection pump disposed in the fluid passage.

8. The system of claim 1, wherein the injector comprises a constant speed injection pump disposed in the fluid passage and a control valve disposed in the fluid passage downstream of the constant speed injection pump.

9. The system of claim 1, wherein the injection point includes a mixing block, and wherein the injector mixes the corrosion inhibitor with the liquid of the liquid piping system.

10. The system of claim 7, further comprising:
a second flow rate sensor configured to determine a flow rate of corrosion inhibitor in the fluid passage,
wherein the amount of corrosion inhibitor injected into the liquid piping system at the injection point is based on the flow rate determined by the flow rate sensor matching the flow rate of corrosion inhibitor determined by the second flow rate sensor.

11. The system of claim 1, further comprising:
a controller operatively coupled to the flow rate sensor and the injector, wherein the controller is configured to:
receive a first signal from the flow rate sensor, the first signal including the flow rate of the liquid entering the liquid piping system;
determine a concentration of the corrosion inhibitor to inject into the liquid piping system based on the flow rate of the liquid entering the liquid piping system;
determine a rate of injection of the corrosion inhibitor based on the flow rate of the liquid entering the liquid piping system and the determined concentration;
generate a second signal instructing the injector to inject the corrosion inhibitor into the liquid piping system at the determined rate of injection; and
transmit the second signal to the injector.

12. The system of claim 11, further comprising:
an external computing device; and
a concentration sensor located at a position in the liquid piping system downstream of the injection point, the concentration sensor operatively coupled to the controller,
wherein the controller is further configured to:
receive, from the concentration sensor, a concentration notification indicating a concentration of corrosion inhibitor in the liquid in the liquid piping system;
determine the concentration of corrosion inhibitor in the liquid in the liquid piping system indicated by the concentration sensor is outside a predetermined range;
generate a third signal indicating the concentration of corrosion inhibitor in the liquid in the liquid piping system is outside the predetermined range; and
electronically transmit the generated signal to the external computing device.

13. The system of claim 12, wherein the third signal is one or more of: a text message, an e-mail, an application notification message, and an audio message.

14. The system of claim 11, further comprising:
an external computing device; and
a quantity sensor located on the vessel, the quantity sensor operatively coupled to the controller,
wherein the controller is further configured to:
receive, from the quantity sensor, a quantity notification indicating a quantity of corrosion inhibitor in the vessel is below a predetermined quantity;
generate a signal indicating the quantity of corrosion inhibitor in the vessel is below the predetermined quantity; and
electronically transmit the generated signal to the external computing device.

15. The system of claim 14, wherein the signal is one or more of: a text message, an e-mail, an application notification message, and an audio message.

16. A method for injecting corrosion inhibitor into a liquid piping system, comprising:
determining, by a flow rate sensor, a flow rate of liquid entering the liquid piping system; and
injecting, by an injector, corrosion inhibitor into the liquid piping system at an injection point in an amount which varies based on the flow rate determined by the flow rate sensor, the injector being disposed in a fluid passage which is connected at a first end to a vessel containing corrosion inhibitor and at a second end to the injection point.

17. The method of claim 16, wherein the amount of corrosion inhibitor injected into the liquid piping system by the injector is an amount of corrosion inhibitor required to maintain a predetermined concentration of corrosion inhibitor in the liquid of the liquid piping system.

18. The method of claim 17, wherein the predetermined concentration of corrosion inhibitor in the liquid of the liquid piping system is between 0.1 percent and 6 percent based on a total volume of liquid in the liquid piping system.

19. The method of claim 16, wherein the injector injects the corrosion inhibitor into the liquid piping system at a controlled rate, the controlled rate causing an even distribution of corrosion inhibitor in the liquid of the liquid piping system.

20. The method of claim 16, further comprising:
determining, by a concentration sensor, a concentration of corrosion inhibitor in the liquid in the liquid piping system; and
generating, by an alarm, an alarm signal if the concentration determined by the concentration sensor is outside a predetermined range.

21. The method of claim 16, further comprising:
determining, by a quantity sensor, a quantity of corrosion inhibitor in the vessel; and
generating, by an alarm, an alarm signal if the quantity of corrosion inhibitor determined by the quantity sensor is below a predetermined quantity.

22. The method of claim 16, wherein the injector comprises a variable speed injection pump disposed in the fluid passage.

23. The method of claim 16, wherein the injector comprises a constant speed injection pump disposed in the fluid passage and a proportional valve disposed in the fluid passage downstream of the constant speed injection pump.

24. The method of claim 16, wherein the injection point includes a mixing block, and wherein the injector mixes the corrosion inhibitor with the liquid of the liquid piping system.

25. The method of claim 22, further comprising:
determining, by a second flow rate sensor, a flow rate of corrosion inhibitor in the fluid passage,
wherein the amount of corrosion inhibitor injected into the liquid piping system at the injection point is based on the flow rate determined by the flow rate sensor matching the flow rate of corrosion inhibitor determined by the second flow rate sensor.

26. The method of claim 16, wherein a controller is operatively coupled to the flow rate sensor and the injector, the method further comprising:
receiving, by the controller from the flow rate sensor, a first signal, the first signal including the flow rate of the liquid entering the liquid piping system;
determining, by the controller, a concentration of the corrosion inhibitor to inject into the liquid piping system based on the flow rate of the liquid entering the liquid piping system;
determining, by the controller, a rate of injection of the corrosion inhibitor based on the flow rate of the liquid entering the liquid piping system and the determined concentration;
generating, by the controller, a second signal instructing the injector to inject the corrosion inhibitor into the liquid piping system at the determined rate of injection; and
transmitting, by the controller the second signal to the injector.

27. The method of claim 26, further comprising:
receiving, by the controller from a concentration sensor, a concentration notification indicating a concentration of corrosion inhibitor in the liquid in the liquid piping system, the concentration sensor located at a position in the liquid piping system downstream of the injection point;
determining, by the controller, the concentration of corrosion inhibitor in the liquid in the liquid piping system indicated by the concentration sensor is outside a predetermined range;
generating, by the controller, a third signal indicating the concentration of corrosion inhibitor in the liquid in the liquid piping system is outside the predetermined range; and
electronically transmitting, by the controller, the third signal to an external computing device.

28. The method of claim 27, wherein the third signal is one or more of: a text message, an e-mail, an application notification message, and an audio message.

29. The method of claim 16, wherein a controller is operatively coupled to the flow rate sensor and the injector, the method further comprising:
receiving, by the controller from a quantity sensor, a quantity notification indicating a quantity of corrosion inhibitor in the vessel is below a predetermined quantity, the quantity sensor located on the vessel;
generating, by the controller, a signal indicating the quantity of corrosion inhibitor in the vessel is below the predetermined quantity; and
electronically transmitting, by the controller, the generated signal to an external computing device.

30. The method of claim 29, wherein the signal is one or more of: a text message, an e-mail, an application notification message, and an audio message.
